(19) United States
(12) Patent Application Publication
(10) Pub. No.: US 2016/0135358 A1
(43) Pub. Date: May 19, 2016

(54) SEED GROWING DEVICE

(71) Applicant: Kathie Lynn Seacord, Commerce Township, MI (US)

(72) Inventor: Kathie Lynn Seacord, Commerce Township, MI (US)

(21) Appl. No.: 15/001,883

(22) Filed: Jan. 20, 2016

Related U.S. Application Data
(63) Continuation-in-part of application No. 14/227,788, filed on Mar. 27, 2014, now abandoned.
(60) Provisional application No. 61/806,718, filed on Mar. 29, 2013.

(51) Int. Cl. A01C 1/04; B65D 73/00

(52) U.S. Cl. CPC A01C 1/044; B65D 73/00

(57) ABSTRACT

A seed mat for placement in a growing medium, such as soil. The seed mat includes a biodegradable mat having at least one opening positioned within an indentation, and a seed that is placed near the opening. The opening is sized smaller than the seed, and the seed is secured below the opening between a bottom biodegradable sheet that is adhered to the bottom surface of the mat. An adhesive is used to adhere the bottom sheet to the mat. The adhesive can optionally include a water-soluble fertilizer.

### CROSS REFERENCE TO RELATED APPLICATION

This application is a continuation-in-part of application Ser. No. 14/227,788, filed Mar. 27, 2014, which claims the benefit of U.S. Provisional Application 61/806,718, which was filed on Mar. 29, 2013, the disclosures of which are hereby incorporated by reference.

### BACKGROUND OF THE INVENTION

1. Field of the Invention

The present invention pertains to a device for properly prespacing seeds. More particularly, the present invention pertains to a biodegradable mat for proper seed placement, giving proper room for growth, lessen the need to weed plants, naturally feeds the plants, and eliminates the need to thin plants.

2. Description of the Prior Art

The conventional method of planting seeds in a garden or elsewhere is to specifically place each seed in its desired location and cover the seed with a growing medium, which is typically soil or water. However, there are ergonomic problems associated with this, especially for elderly people or those who are disabled. Planting seeds in this matter requires the user to usually kneel on the ground. Additional time is spent kneeling and bending over to pull weeds and thin the plants. In addition, it can be difficult to accurately remember where each seed is located once it has been buried in the soil.

But even more so, there is difficulty in planting very small seeds which can be difficult to see and handle. Thus, there remains a need for a device and method that makes it easier by aiding the process of time-consuming jobs like pulling weeds and thinning plants, and also naturally feeds the plants and eliminates the need to use weed killers.

The present invention, as is detailed hereinbelow, seeks to address this problem by providing a biodegradable mat having at least one indentation and opening for positioning a seed, and a biodegradable sheet that is adhered to the mat and secures the seed near the opening. The mat keeps the seeds equally-spaced, stops the need to thin plants, keeps weeds from growing, and adds nutrients.

### SUMMARY OF THE INVENTION

The present invention provides a seed mat for placement in a growing medium comprising:

(a) a biodegradable mat having a top surface and a bottom surface, and including at least one indentation and opening, the opening being positioned within the indentation;

(b) a seed positioned below the opening, and the opening being smaller than the seed so that the seed cannot pass through the opening; and

(c) a bottom biodegradable sheet adhered to the bottom surface of the mat in which the biodegradable sheet secures the seed against the opening in the mat.

Optionally, the mat comprises railroad board, recycled paper, paper pulp, or wood, and the bottom sheet is tissue paper.

In another aspect hereof, there is provided a method of manufacturing a seed mat including the steps of:

(a) providing a biodegradable sheet having a top surface and a bottom surface, at least one seed, and a sheet of biodegradable paper;

(b) penetrating through the biodegradable sheet from the top surface toward the bottom surface to make at least one opening in the biodegradable sheet;

(c) positioning at least one of the seeds at the opening against the bottom surface of the biodegradable sheet; and

(d) adhering the sheet of biodegradable paper to the bottom surface of the biodegradable sheet by wetting the sheet of biodegradable paper and placing the sheet of biodegradable paper against the bottom surface of the biodegradable sheet, whereby the seed is held in position between the biodegradable paper and the biodegradable sheet.

Optionally, the opening is made in the biodegradable sheet by drilling or punching an object through the biodegradable sheet. Optionally, this method also includes the step of creating an indentation around each opening

In another embodiment hereof, there is provided:

(a) a biodegradable mat having a top surface, a bottom surface, and including at least one opening;

(b) a seed positioned against the bottom surface of the mat below the opening;

(c) a bottom biodegradable sheet adhered to the bottom surface of the mat;

and

(d) an adhesive comprising water and a water-soluble fertilizer, the adhesive being positioned between the bottom sheet and the mat to adhere the bottom sheet to the mat;

(e) whereby the bottom sheet secures the seed against the bottom surface of the mat at the opening

In yet another embodiment hereof, there is provided:

(a) a greeting card;

(a) a biodegradable mat having a top surface, a bottom surface, and including at least one opening, the biodegradable mat being connected to the greeting card;

(b) a seed positioned below the opening; and

(c) a bottom biodegradable sheet adhered to the bottom surface of the mat;

(d) whereby the bottom sheet secures the seed below the opening in the mat.

Optionally, the biodegradable mat is in the form of a predefined shape, such as a heart, a cross, letters, numbers, and so forth.

Optionally, the biodegradable mat is releasably connected to the greeting card.

In yet another embodiment, there is provided a seed mat for placement on a growing medium comprising:

(a) a biodegradable mat having a top surface and a bottom surface, and including at least one opening, the opening being centered within an indentation;

(b) a seed positioned in the indentation and above the opening; and

(d) a top biodegradable sheet adhered to the top surface; whereby the top sheet secures the seed above the opening in the mat.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a top perspective view of a first embodiment of the present invention hereof;

FIG. 2 is an enlarged cross-sectional view of the seed mat;

FIG. 3 is a cross-sectional view showing the diameter of the opening at the top surface being wider than the diameter of the opening at the bottom surface of the mat;

FIG. 4 is an embodiment of the invention including a greeting card having the seed mat releasably attached thereto; and

FIG. 5 shows an alternative embodiment of the invention in which the seed is positioned in the indentation and above the opening.

### DETAILED DESCRIPTION OF THE INVENTION

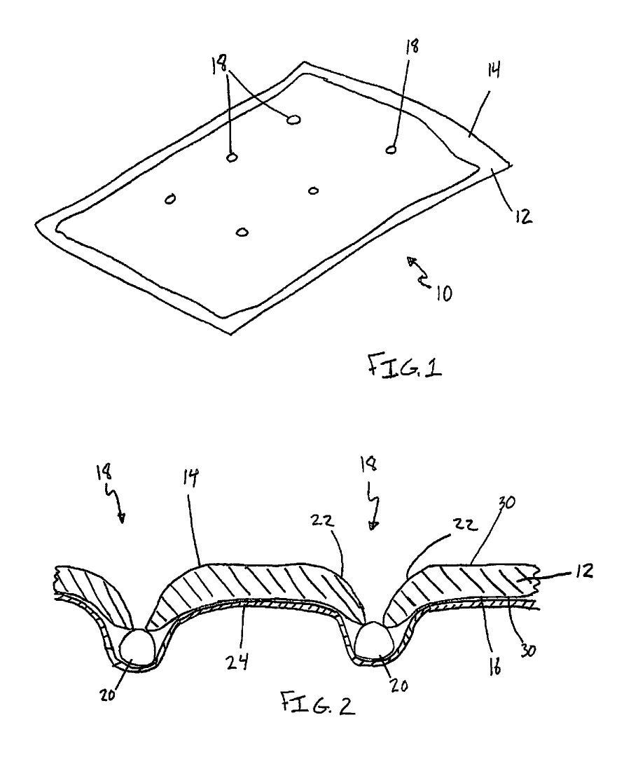

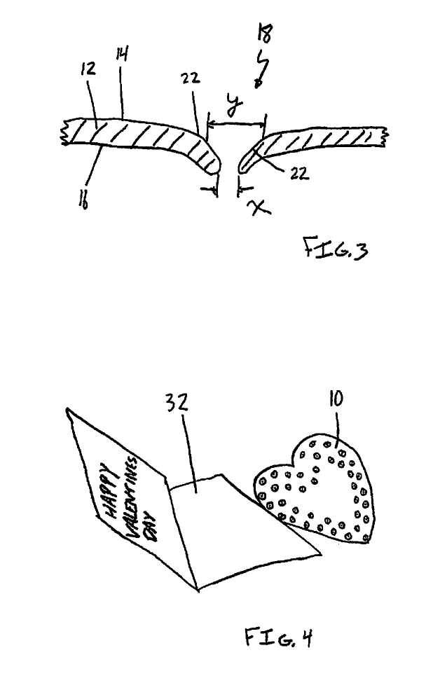

In accordance with the present invention, and as shown generally in FIG. 1, and cross-sectionally in FIG. 2, there is provided a seed mat 10 for placement in a growing medium comprising: (a) a biodegradable mat 12 having a top surface 14 and a bottom surface 16, and including at least one opening 18 for positioning a seed 20, the opening 18 being positioned within an indentation 22; and (b) a bottom biodegradable sheet 24 adhered to the bottom surface 16 of the mat 12, whereby the bottom sheet 24 secures the seed 20 against the bottom surface 16 near the opening 18 in the mat 12.

The biodegradable mat 12 is a flat sheet of biodegradable material that can be any desirable shape, such as square, rectangular, circular, and so forth. The mat 12 is formed from any suitable biodegradable material, but preferably it is formed from a cellulosic material such as paper, railroad board (also known as Bristol board or Bristol paper), cardboard, recycled paper, paper pulp, wood, or the like. Although it is preferable that the mat 12 has some degree of flexibility to it, it is preferable that it have sufficient mass to absorb water. Preferably the mat 12 is formed from a cellulosic material having a pound weight of about 50 pounds to about 110 pounds. As understood by those having ordinary skill in the art, “pound weight” is a standardized measurement of a sheet of material, and in particular, it refers to the weight of 500 sheets of 20″×26″ paper. For example, typical copy paper is usually about 20 pounds.

It is also preferable that the mat 12 is absorbent. In this regard, the mat 12 soaks in water and helps maintain a relatively constant, stable, and desirable level of moistness for the seed 20. This environment, which is neither dry nor overly wet, will dramatically increase the rate of seed germination. The mat 12 will also reduce watering, reduce soil erosion, and improves soil conditions.

The mat 12 has a top surface 14 and a bottom surface 16, and at least one opening 18 for positioning a seed 20. When more than one seed 20 is provided, the openings 18 also properly space the seeds 20 from each other. In one embodiment, the opening 18 is positioned within a downward indentation 22. The opening 18 can be created using any suitable method that is well-known to those having ordinary skill in the art. For example, the opening can be pressed or drilled in either a stack of mats or in a single mat. The opening 18 can also be created using any other suitable method, such as by applying pressure to the opening 18 to press the indentation 22 and force the opening 18. The indentation 22 is formed when it is pressed and forms a protruding cell that protrudes past the mat 12.

Preferably, and as shown in FIG. 3, the diameter x of the opening 18 on the bottom surface 16 of the mat 12 is less than the diameter y of the opening 18 on the top surface 14 of the mat 12. The indentation 22 surrounding the opening 18 works together with the opening 18 having a smaller diameter at the bottom surface 16 to help position a seed 20 under each opening 18. When the seed 20 germinates, then the sprout grows upwardly through the opening 18. The sprout will root down into the growing medium.

In addition, there is provided a bottom sheet 24 that is adhered to the bottom surface 16 of the mat 12. The bottom sheet 24 is also preferably biodegradable. The bottom sheet 24 is preferably formed from a lightweight cellulosic material, such as tissue paper. When the seed 20 is positioned below the opening 18 of the mat 12 and the bottom sheet 24 is adhered to the bottom surface 16 of the mat 12, the seed 20 is secured below the opening 18 and positioned against the opening 18 to allow the plant to grow through the opening 18.

The bottom sheet 24 is adhered to the bottom surface 16 of the mat 12 with an adhesive 30. The adhesive 30 can be misted on the sheet 24. Alternatively, the adhesive 30 can be a non-toxic spray adhesive. In use, each of the seeds 20 is placed against a respective opening 18 and sprayed with the adhesive 30 to keep the seed 20 in position against the bottom surface 16 of the mat 12. The wetted, or misted sheet 24 is then placed against the bottom surface 16 of the mat 12. The wetted sheet 24 will remain adhered to the mat 12 after they have dried.

According to another aspect hereof, the adhesive 30 can optionally comprise a water-soluble fertilizer that is dissolved into the water of the adhesive 30. Any suitable type of water-soluble fertilizer can be used herewith, but preferably the fertilizer is an all-purpose plant food, such as the “Water Soluble All Purpose Plant Food 24-8-16” sold under the trademark Miracle-Gro®. It is understood by those having ordinary skill in the art that the numbers “24-8-16” represent the percentage of nitrogen, phosphate, and potash, respectively. It is also to be understood that varying mixtures of nitrogen, phosphate, and potash can be used herewith.

The mat 12 can include any number of openings 18. For example, the mat 12 can be as small as 1 inch wide or less and include only a single opening 18 and seed 20. In this application, the user is able to easily place the single seed 20 wherever he or she wishes. On the other end of the spectrum, the mat 12 can be very large in size—even so large that it can cover an entire garden. The openings 18 and seeds 20 in the mat 12 are pre-positioned for equal spacing of the plants to grow.

For example, if the seeds 20 are for a variety of different vegetables in a vegetable garden, then the openings 18 and the seeds 20 can be properly spaced from each other as required for each type of plant. In another example, the seeds 20 can be for different flowers and pre-positioned for a pre-arranged flower bed or to create a specific design (for example, in the shape of a heart). In another example, the seed mat 10 includes only a single type of seed, and the seeds 20 are evenly spaced from each other at a distance predetermined to be optimal for that particular species of plant. It is to be understood that any suitable type of seed 20 can be used herewith.

The mat 12 can also include an arrangement of seeds 20 that should be planted at the same time in the growing calendar. Thus, various mats can be placed in the garden at pre-specified times depending upon the hardiness zone and the requirements of the seeds 20. Therefore, a kit can be sold which has multiple mats, and each mat 12 should be placed in the garden at a specified time as required by the seeds 20 on that particular mat 12.

In use, the user simply places the seed mat 10 in the desired location on the soil, covers the seed mat 10 with a small amount of soil (approximately 1 inch deep), and waters the seeds 20. The mat 12 and the bottom sheet 24 retain moisture, thereby helping the seeds 20 to germinate. The bottom sheet 24 biodegrades relatively quickly—within a matter of days or weeks, and the mat 12 will also biodegrade after that. The mat 12 may also help reduce evaporation of water out of the soil, thereby helping provide the seedling with sufficient moisture. The mat 12 keeps plants growing and spaced enough away from each other for proper growth of the plant. The mat 12 can also assist in deterring weed growth.

In use, the seed mat 10 is placed on the soil and is covered with a shallow bed of soil (approximately 1 inch). The mat 12 will absorb water and provide a barrier to help deter weeds from growing. The bottom sheet 24 will biodegrade relatively quickly. The seed 20 will then germinate and begin to grow roots downwardly. The seed 20 will sprout upwardly through the opening 18. The mat 12 will slowly biodegrade as the plant continues to grow. Optionally, the adhesive 30 can include a fertilizer that will also help the seedling grow. The seeds 20 are evenly-spaced at an optimal distance from each other, which also means that seedlings do not need to be thinned, or pulled, to allow the strongest seedlings to thrive.

In another aspect hereof, there is provided a method of manufacturing a seed mat 10 including the steps of: (a) providing the biodegradable sheet of railroad board 12, at least one seed 20, and a sheet of biodegradable tissue paper 24; (b) making at least one opening 18 in the railroad board 12 by penetrating an object through the railroad board 12; (c) positioning at least one of the seeds 20 at the opening 18 against the bottom surface 16 of the biodegradable sheet 12; and adhering the sheet of tissue paper to a bottom surface 16 of the railroad board 12 by wetting the tissue sheet and placing the tissue sheet against the bottom surface 16 of railroad board 12, whereby the seed is held in position between the biodegradable paper and the biodegradable sheet.

Optionally, this method can also include the steps of drilling or punching an object through the railroad board 12 to make the opening 18. Optionally, and preferably, this method also includes the step of creating an indentation 22 around each opening 18.

Alternatively, and as shown in FIG. 5, there is also provided a seed mat for placement on a growing medium in which the seed is placed above the biodegradable mat and positioned in the indentation above the hole. This embodiment includes a top biodegradable sheet 26 adhered to the top surface 14 that secures the seed above the opening in the mat.

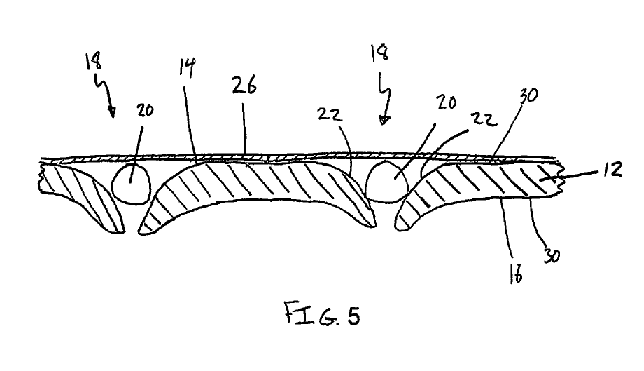

In yet another embodiment of the invention, and as shown in FIG. 4, there is provided a greeting card 32 having the seed mat 10 attached thereto. The seed mat 10 is releasably connected to the greeting card 32, such as by being ripped. Preferably, the seed mat 10 is formed from the same sheet of material as the greeting card 32. Optionally, the biodegradable mat 12 is in the form of a predefined shape, such as a heart, a cross, letters, numbers, and so forth. In this manner, the type of greeting card 32 is intended to correspond to the shape of the seed mat 10. For example, a bereavement card can have a seed mat 10 in the shape of a cross or the Star of David. Likewise, a birthday card could have a seed mat 10 in the shape of a number corresponding to the recipient's age, or a Valentine's Day card could be in the shape of a heart (as shown in FIG. 4).

According to the invention described above, there is provided a biodegradable mat having at least one opening for receiving a seed, and a biodegradable sheet that is adhered to the mat and secures the seed near the opening

What is claimed is:

1. A seed mat for placement in a growing medium comprising:
a biodegradable mat having a top surface and a bottom surface, and including at least one opening;
a seed positioned below the opening, and the opening being smaller than the seed so that the seed cannot pass through the opening; and
a bottom biodegradable sheet adhered to the bottom surface of the mat in which the biodegradable sheet secures the seed against the opening in the mat.

2. The seed mat of claim 1 in which the mat is formed from railroad board, and the bottom biodegradable sheet is formed from tissue paper.

3. The seed mat of claim 2 including an indentation, wherein the opening is positioned within the indentation.

4. The seed mat of claim 3, wherein the opening has a larger diameter at the top surface of the mat than the diameter of the opening at the bottom surface of the mat.

5. The seed mat of claim 1 including an adhesive for adhering the bottom biodegradable sheet to the mat.

6. The seed mat of claim 5 wherein the adhesive includes a water-soluble fertilizer.

7. The seed mat of claim 1, wherein the opening has a larger diameter at the top surface of the mat than the diameter of the opening at the bottom surface of the mat.

8. A seed mat for placement in a growing medium comprising:
a biodegradable mat having a top surface and a bottom surface, and including at least one opening;
a seed positioned above the opening, and the opening being smaller than the seed so that the seed cannot pass through the opening; and
a top biodegradable sheet adhered to the top surface of the mat so that the biodegradable sheet secures the seed above the opening in the mat.

9. The seed mat of claim 8 in which the mat is formed from railroad board, and the top biodegradable sheet is formed from tissue paper.

10. The seed mat of claim 9 including an indentation, wherein the opening is positioned within the indentation.

11. The seed mat of claim 10, wherein the opening has a larger diameter at the top surface of the mat than the diameter of the opening at the bottom surface of the mat.

12. The seed mat of claim 8 including an adhesive for adhering the top biodegradable sheet to the mat.

13. The seed mat of claim 12 wherein the adhesive includes a water-soluble fertilizer.

14. The seed mat of claim 8, wherein the opening has a larger diameter at the top surface of the mat than the diameter of the opening at the bottom surface of the mat.

15. An article of manufacture comprising:
a greeting card;
a biodegradable mat having a top surface, a bottom surface, and including at least one opening, the biodegradable mat being connected to the greeting card;
a seed positioned below the opening; and
a bottom biodegradable sheet adhered to the bottom surface of the mat;
whereby the bottom biodegradable sheet secures the seed below the opening in the mat.

16. The article of manufacture of claim 15 in which the mat and the greeting card are formed from railroad board, and the bottom biodegradable sheet is formed from tissue paper.

17. The article of manufacture of claim 16 including an adhesive for adhering the bottom biodegradable sheet to the mat, the adhesive having a water-soluble fertilizer.

18. The article of manufacture of claim 17, wherein the opening has a larger diameter at the top surface of the mat than the diameter of the opening at the bottom surface of the mat.

19. The article of manufacture of claim 18 including an adhesive for adhering the bottom biodegradable sheet to the mat, the adhesive having a water-soluble fertilizer.

20. The article of manufacture of claim 15, wherein the opening has a larger diameter at the top surface of the mat than the diameter of the opening at the bottom surface of the mat.
